(19) United States
(12) Patent Application Publication
(10) Pub. No.: US 2011/0300054 A1
(43) Pub. Date: Dec. 8, 2011

(54) METHOD OF USING AN OXYGEN WASTE STREAM AS AN OXIDIZER FEED GAS STREAM

(76) Inventors: Ilaria CIATTAGLIA, Munich (DE); Albrecht HEINZEL, Munich (DE)

(21) Appl. No.: 12/792,070

(22) Filed: Jun. 2, 2010

(51) Int. Cl. C01B 31/20

(52) U.S. Cl. 423/437.1

(57) ABSTRACT

A method for producing carbon dioxide using the waste gas oxygen stream from an air separation unit producing nitrogen as the oxygen feed. The oxygen is fed to an autothermal reformation or partial oxidation unit to produce synthesis gas which is subjected to a shift reaction to produce hydrogen and carbon dioxide. The carbon dioxide is separated and recovered and can be employed in an enhanced oil recovery operation.

### BACKGROUND OF THE INVENTION

The invention relates to a method for using the oxygen waste stream from an air separation unit producing nitrogen for enhanced oil recovery as a oxidizer for an autothermal reforming/partial oxidation process to produce synthesis gas. The synthesis gas then undergoes a shift reaction whereby hydrogen and carbon dioxide are produced. The hydrogen can be employed to power the air separation unit and the carbon dioxide can be used for enhanced oil recovery. The presented method maximizes the amount of CO2 and N2 available for EOR.

Oil or gas and any water which is contained in the porous rock surrounding the oil or gas in a reservoir or formation are typically under pressure due to the weight of the material above them. As such, they will move to an area of lower pressure and higher elevation such as the well head. After some pressure has been released, the oil may still flow to the surface but it does so more slowly. This movement can be helped along by a mechanical pump such as the grasshopper pumps one often sees. These processes are typically referred to as primary oil recovery. Typically, less than 50% of the oil in the oil formation is recovered by primary techniques. Recovery can be increased by pursuing enhanced oil recovery (EOR) methods. Typically, these methods are divided into two groups: secondary and tertiary.

Secondary EOR generally refers to pumping a fluid, either liquid or gas, into the ground to build back pressure that was dissipated during primary recovery. The most common of these methods is to inject water and is simply called a waterflood.

The tertiary recovery schemes typically use chemical interactions or heat to either reduce the oil viscosity so the oil flows more freely or to change the properties of the interface between the oil and the surrounding rock pores so that the oil can flow out of the small pores in the rock and enter larger channels where the oil can be swept by a driving fluid or move by pressure gradient to a production well. The oil may also be swelled so that a portion of the oil emerges from small pores into the channels or larger pores in the rock. Typical of these processes are steam injection, miscible fluid injection and surfactant injection.

Thermal techniques employing steam can be utilized in a well to well scheme or also in a single-well technique which is know as the huff and puff method. In this method, steam is injected via a well in a quantity sufficient to heat the subterranean hydrocarbon-bearing formation in the vicinity of the well. The well is then shut in for a soaking period after which it is placed on production. After production has declined, the huff and puff method may again be employed on the same well to again stimulate production.

The use of carbon dioxide and its injection into oil reservoirs is known for well to well and single well production enhancement. The carbon dioxide dissolves in the oil easily and causes the oil to swell and reduces the viscosity and surface tension of the oil which in turn leads to additional oil recovery. The carbon dioxide may also be employed with steam such that the steam and carbon dioxide are injected either simultaneously or sequentially, often followed by a soak period, followed by a further injection of carbon dioxide or other fluids.

A facility that produces nitrogen for enhanced oil recovery can advantageously be modified to produce carbon dioxide for EOR. This modification needs to be accomplished with minimal modifications to the existing plant of an air separation unit powered by a natural gas fueled combined cycle power plant.

Traditionally carbon dioxide for EOR was captured in the gas turbine vent gas using an amine based solvent absorption system. The carbon dioxide can be recovered using a carbon dioxide-precombustion removal technology.

The inventors have discovered that the use of an enriched-oxygen feed stream in conjunction with a carbon rich fuel gas stream for synthesis gas production and downstream conversion would provide the carbon dioxide for EOR with minimal changes to the existing plant and decreased carbon dioxide emissions.

### SUMMARY OF THE INVENTION

The invention is a method for producing carbon dioxide for use in enhanced oil recovery comprising the steps of feeding an enriched oxygen air gas stream and a carbon rich fuel gas stream to an autothermal reformation/partial oxidation process; recovering the synthesis gas formed by the autothermal reformation process and feeding it to a shift reactor to produce hydrogen and carbon dioxide; feeding the hydrogen and carbon dioxide to a carbon dioxide removal unit whereby carbon dioxide is recovered.

The remaining hydrogen rich gas is burnt in a combined cycle power plant that provides the power to drive the air separation units. The hydrogen rich fuel gas has to be diluted by nitrogen before it is fed to the burners of the gas turbine. The N₂-dilution is required to secure a safe and environmental friendly operation. If one took the nitrogen that is produced for enhanced oil recovery (EOR) in the end less nitrogen would be available for EOR. As such, the invention takes the waste oxygen from the air separation unit (ASU) which still contains some nitrogen to blow the autothermal reformation/partial oxidation. This waste oxygen may be blended with some air (Option 2 as further detailed with regards to FIG. 2 below). Thus the nitrogen content of the hydrogen rich fuel gas can be adjusted to meet the maximum allowable hydrogen content of the gas turbine burners without consuming any of the nitrogen dedicated for EOR. Alternatively some of the nitrogen that is dedicated for EOR can be used to dilute the hydrogen rich gas (Option 2). Option 2 would reduce the amount of nitrogen available for EOR.

The enriched oxygen air gas stream is about 70 to 80% by volume oxygen and may be obtained as the waste gas stream from an air separation unit which is producing nitrogen for use in the enhanced oil recovery process. The oxygen from the air separation unit in one embodiment can be supplemented with air to make the enriched oxygen air gas stream. The use of the oxygen enriched exhaust stream from the air separation unit will have benefits in not only a reduction of plant size but also saves compressor power due to reduced processing of nitrogen needed.

The carbon rich fuel gas stream may be selected from any carbon containing stream that has a heating value greater than zero. In particular, the carbon rich fuel gas stream is a hydrocarbon or mixture of hydrocarbons selected from the group consisting of natural gas, oil, coal, refinery off gases and biomass.

The autothermal reformation/partial oxidation process is a single reactor which converts a fuel such as natural gas through a combination of partial oxidation and catalytic conversion to produce synthesis gas. In the partial oxidation section of the reactor, the natural gas is mixed with air and/or oxygen and steam in a burner or mixer where the partial combustion reaction takes place. This step is followed by a reformation reaction such as a steam methane reformation (SMR) reaction. The synthesis gas produced by this autothermal reformation/partial oxidation process is then followed by a shift conversion performed at high temperature and in the presence of a catalyst to form carbon dioxide and additional hydrogen.

The basic reactions are as such:

Partial Oxidation CH₄+½O₂=CO+2H₂

### Steam Methane Reforming: CH₄+H₂O=CO+3H₂

Shift conversion: CO+H₂O=CO₂+H₂

The combination of the non-catalytic partial oxidation and catalytic reformation results in an overall process that is relatively more energy efficient than using these two reaction units separately since the heat produced in the partial oxidation process can be transferred directly to the reformation reaction. Further, the size of the autothermal reformation/partial oxidation process unit can be minimized by use of the waste oxygen stream from the air separation process. Preferably, the autothermal reformation/partial oxidation process will provide synthesis gas having 65% maximum hydrogen content which is the target maximum for the combined cycle power plant.

The shift catalyst in the second reactor can be a low temperature shift catalyst or water gas shift reactor catalyst.

The shift reactor can be followed by a cooling step which will lower the temperature of the carbon dioxide and hydrogen prior to entry into the carbon dioxide removal unit.

In further embodiments of the invention, the hydrogen and carbon dioxide products of the shift reaction are fed to a carbon dioxide removal unit whereby carbon dioxide is recovered for use in the EOR process. The carbon dioxide separation is typically a MDEA physical wash process wherein 90% of the carbon dioxide can be recovered from the starting carbon rich fuel gas. However, other carbon dioxide separation means may be employed wherein both hydrogen and carbon dioxide are separated and recovered.

The hydrogen that is separated out is fed to a combined cycle power plant as fuel with the resulting waste flue gas being very low in carbon dioxides. The combined cycle power plant will provide power to the air separation unit producing the nitrogen for use in the EOR process. The combined cycle power plant is typically a gas turbine generator (GTG) and heat recovery steam generator (HRSG). The HRSG receives hot exhaust from a gas turbine to generate steam which in turn drives a steam turbine. This combination of GTG and HRSG will produce electricity which can be used to provide power to the air separation facility.

Some nitrogen may be recovered from the air separation unit product gas stream and it may be fed along with the hydrogen rich fuel gas from the carbon dioxide removal unit to dilute the fuel gas stream entering the combined cycle power plant. This is necessary as the content of the synthesis gas will have too much hydrogen (around 85%) which must be diluted down to about 65% for use in a gas turbine generator. This will enable the operator to avoid having to combine the enriched oxygen air gas stream with air.

### BRIEF DESCRIPTION OF THE DRAWINGS

FIG. 1 is a schematic depiction of the invention where nitrogen from an air separation unit is fed to the hydrogen rich fuel gas line.

FIG. 2 is a schematic depiction of the invention where supplemental air feed is fed to the oxygen enriched air entering the autothermal reactor or partial oxidation reactor.

### DETAILED DESCRIPTION OF THE INVENTION

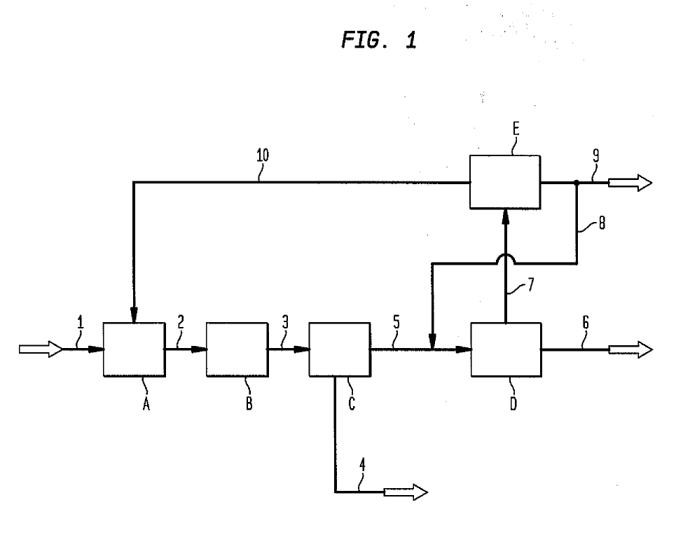

Turning to the drawings, FIG. 1 is a schematic of the invention whereby nitrogen is withdrawn from the product nitrogen from the air separation unit and combined with hydrogen rich fuel gas to dilute the fuel gas prior to entering the combined cycle power plant.

A carbon rich fuel is fed through line 1 to the autothermal reformation unit or partial oxidation unit A. The carbon rich fuel gas stream may be selected from any carbon containing stream that has a heating value greater than zero. In particular, the carbon rich fuel gas stream is a hydrocarbon or mixture of hydrocarbons selected from the group consisting of natural gas, oil, coal, refinery off gases and biomass. The waste gas stream 10 from the air separation unit E is primarily oxygen enriched air of about 70 to 80 volume percent oxygen which is fed to the autothermal reformation unit or partial oxidation unit A. Optionally, the oxygen enriched air can be fed through a booster compressor, not shown, prior to entering the autothermal reformation/partial oxidation unit. The autothermal reformation unit/partial oxidation unit will convert the oxygen and carbon rich feed into synthesis gas rich in hydrogen and carbon dioxide which is fed through line 2 to shift reactor B.

The partial oxidation or autothermal reforming unit is operated at a pressure of 10 to 100 bara. The partial oxidation process produces a raw gas at approximately 1300° to 1400° C. The raw gas is cooled down in a synthesis gas cooler or is quenched by water injection. The autothermal reforming process produces a raw synthesis gas at 900° to 1100° C. and is also cooled down in a synthesis gas cooler or quenching by water injection.

The shift reactor will produce a stream 3 of carbon dioxide and hydrogen which is fed to a carbon dioxide removal unit C where carbon dioxide which can be used in an enhanced oil recovery operation is withdrawn through line 4. The hydrogen rich fuel gas will exit the carbon dioxide removal unit C through line 5 where it will enter the combined cycle power plant D. Part of the nitrogen produced by the air separation unit E is withdrawn from line 9 through line 8 where it will combine with the hydrogen rich fuel gas in line 5 prior to entry into the combined cycle power plant D. The combined cycle power plant D will provide power through line 7 to the air separation unit E while producing a flue gas through line 6 that is very low in carbon dioxide content. The air separation unit E produces the nitrogen which is directed through line 9 for use in enhanced oil recovery. The hydrogen rich fuel gas can also be converted into electricity by using a fuel cell (not shown).

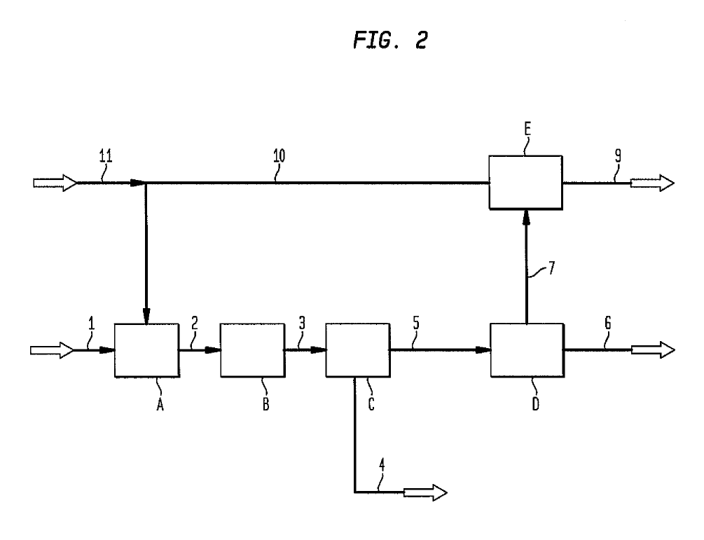

FIG. 2 uses the same designations for lines and operational units as FIG. 1 does. In the embodiment shown in FIG. 2, supplemental air is directed through line 11 to join with the oxygen enriched air in line 10 from the air separation unit E. This combined blended air/oxygen enriched air will enter the autothermal reformation unit or partial oxidation unit through line 10. Further in this embodiment, product nitrogen is not withdrawn from line 9 to be directed to the hydrogen rich fuel gas entering the combined cycle power plant D through line 5.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the invention.

1. A method for producing carbon dioxide comprising the steps of feeding an enriched oxygen air gas stream and a carbon rich fuel gas stream to an autothermal reformation/partial oxidation process, wherein said enriched oxygen air gas stream is a waste gas stream from an air separation unit;
recovering the synthesis gas formed by the autothermal reformation process and feeding said synthesis gas to a shift reactor to produce hydrogen and carbon dioxide; and feeding the hydrogen and carbon dioxide to a carbon dioxide removal unit whereby carbon dioxide is recovered.

2. The method as claimed in claim 1 wherein said carbon rich fuel gas stream is selected from the group consisting of natural gas, oil, coal, refinery off gases and biomass.

3. (canceled)

4. (canceled)

5. (canceled)

6. (canceled)

7. (canceled)

8. (canceled)

9. The method as claimed in claim 1 wherein said recovered carbon dioxide is used in an enhanced oil recovery process.

10. The method as claimed in claim 1 wherein said hydrogen is fed to a combined cycle power plant as fuel.

11. The method as claimed in claim 1 wherein said combined cycle power plant provides power to said air separation unit.

12. The method as claimed in claim 1 wherein said air separation unit is producing nitrogen.

13. The method as claimed in claim 8 wherein said nitrogen is used in enhanced oil recovery.

14. The method as claimed in claim 9 wherein a portion of said nitrogen is fed to said hydrogen being fed to said combined cycle power plant.

15. The method as claimed in claim 9 wherein some air is blended to the waste oxygen gas stream.

16. The method as claimed in claim 10 wherein said combined cycle power plant is a gas turbine generator and heat recovery steam generator.

17. The method as claimed in claim 1 wherein said carbon dioxide is used in enhanced oil recovery
